(19) United States
(12) Patent Application Publication
(10) Pub. No.: US 2023/0158921 A1
(43) Pub. Date: May 25, 2023

(54) ELECTRIC MILEAGE ESTIMATION APPARATUS, ELECTRIC MILEAGE ESTIMATION METHOD, AND RECORDING MEDIUM

(71) Applicant: Panasonic Intellectual Property Management Co., Ltd., Osaka (JP)

(72) Inventors: Takuma IIDA, KANAGAWA KEN (JP); Takayuki IWASAKI, KANAGAWA KEN (JP); Masaaki HOSHIDA, OSAKA FU (JP); Masato WAGATSUMA, KANAGAWA KEN (JP); Mutsuki MATSUSHITA, KYOTO FU (JP)

(73) Assignee: Panasonic Intellectual Property Management Co., Ltd., Osaka (JP)

(21) Appl. No.: 18/099,785

(22) Filed: Jan. 20, 2023

Related U.S. Application Data
(63) Continuation of application No. PCT/JP2021/019249, filed on May 20, 2021.

(30) Foreign Application Priority Data
Jul. 31, 2020 (JP) 2020-131125

(51) Int. Cl. B60L 58/10

(52) U.S. Cl. CPC B60L 58/10; B60L 2260/52; B60L 2260/54

(57) ABSTRACT

An electric mileage estimation apparatus includes a storage device and a hardware processor connected to the storage device. The storage device stores information in which traveling history information is associated with an electric mileage of traveling. The traveling history includes a characteristic of a driver. The hardware processor acquires information about a traveling schedule including a characteristic of a driver. The hardware processor calculates an electric mileage estimation value on the basis of the information about the traveling schedule and parameters calculated from the information stored in the storage device. The hardware processor outputs information based on the electric mileage estimation value.

### CROSS-REFERENCE TO RELATED APPLICATIONS

This application is a continuation of International Application No. PCT/JP2021/019249, filed on May 20, 2021, which claims the benefit of priority of the prior Japanese Patent Application No. 2020-131125, filed on Jul. 31, 2020, the entire contents of which are incorporated herein by reference.

### FIELD

The present disclosure relates generally to an electric mileage estimation apparatus, an electric mileage estimation method, and a recording medium.

### BACKGROUND

In recent years, there is disclosed a technique of calculating an estimated energy consumption amount as energy consumed per unit time by a moving object at the time of traveling, calculating an actual energy consumption amount consumed by the moving object per unit time, and estimating a section energy amount using the estimated energy consumption amount and the actual energy consumption amount (for example, WO 2014/049878).

### SUMMARY

An electric mileage estimation apparatus according to the present disclosure includes a storage device and a hardware processor connected to the storage device. The storage device is configured to store information in which traveling history information is associated with an electric mileage of traveling. The traveling history including a characteristic of a driver. The hardware processor is configured to acquire information about a traveling schedule including a characteristic of a driver. The hardware processor is configured to calculate an electric mileage estimation value on the basis of the information about the traveling schedule and parameters calculated from the information stored in the storage device. The hardware processor is configured to output information based on the electric mileage estimation value.

### BRIEF DESCRIPTION OF THE DRAWINGS

FIG. 1 is an overview configuration diagram of a delivery management system according to an embodiment;

FIG. 2 is a diagram for explaining a data structure of delivery data;

FIG. 3 is a diagram for explaining a data structure of measurement data;

FIG. 4 is a block diagram illustrating an example of a hardware configuration of a power consumption prediction system;

FIG. 5 is a functional block diagram of the power consumption prediction system;

FIG. 6 is a diagram for explaining a data structure of information stored in a traveling electric mileage information storage unit;

FIG. 7 is a list of types of parameters;

FIG. 8 is a flowchart illustrating a processing procedure for calculating an electric mileage estimation value;

FIG. 9 is a flowchart illustrating a processing procedure for registering registration candidate data;

FIG. 10 is a diagram for explaining a change amount and a presence amount of traveling data;

FIG. 11 is a diagram illustrating an example of a change amount and a presence amount of a driver whose electric mileage is good; and

FIG. 12 is a diagram illustrating an example of a change amount and a presence amount of a driver as a specific determination target.

### DETAILED DESCRIPTION

The following describes an embodiment of a delivery management system according to the present disclosure with reference to the drawings.

Schematic Configuration of Delivery Management System

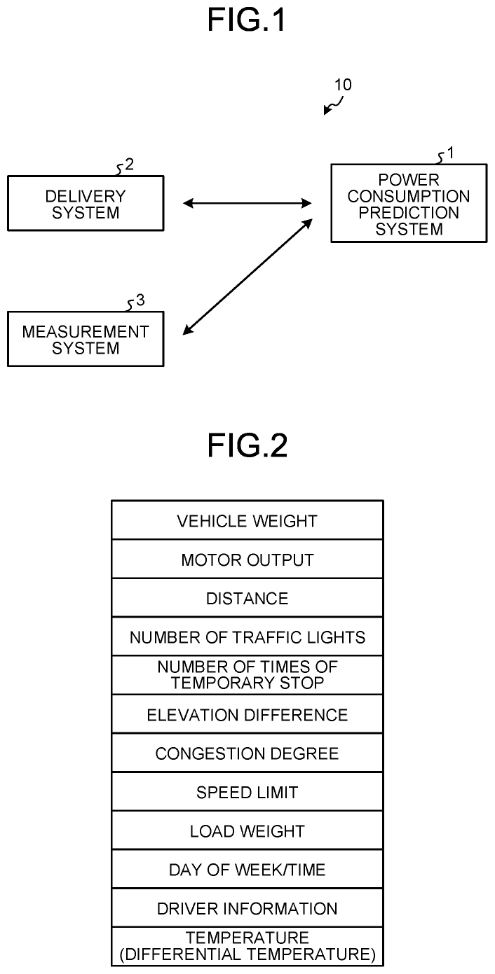

FIG. 1 is an overview configuration diagram of the delivery management system according to the embodiment. A delivery management system 10 includes a power consumption prediction system 1, a delivery system 2, and a measurement system 3. The power consumption prediction system 1 and the delivery system 2 are capable of transmitting/receiving information to/from each other over a network. The power consumption prediction system 1 and the measurement system 3 are also capable of transmitting/receiving information to/from each other over the network.

The delivery management system 10 is a system that manages a delivery state of an electric vehicle. The delivery management system 10 sets a delivery route for the electric vehicle, and calculates a power consumption of the electric vehicle in a case of traveling on the delivery route. The delivery management system 10 also manages a traveling history and an electric mileage of the electric vehicle to calculate the power consumption.

The power consumption prediction system 1 is an information processing device such as a server device. The power consumption prediction system 1 may be implemented with a plurality of server devices capable of performing processing in corroboration with each other via a network. The power consumption prediction system 1 may also be a server device on a cloud. The power consumption prediction system 1 acquires measurement data from the measurement system 3 and saves the measurement data. The measurement data described above is information including, for example, information about an electric mileage. In addition, when delivery data as information about delivery and a request for calculation of a power consumption are received from the delivery system 2, the power consumption prediction system 1 estimates an electric mileage on the basis of the delivery data and parameters obtained from the traveling history and the electric mileage of the electric vehicle stored in advance. Then the power consumption prediction system 1 calculates a power consumption on the basis of the electric mileage and outputs the power consumption to the delivery system 2. In this manner, the power consumption prediction system 1 functions as an electric mileage estimation apparatus.

The delivery system 2 is, for example, an information processing device such as a server device. The delivery system 2 searches for a delivery route using map information and generates information about a delivery plan. The delivery system 2 transmits, to the power consumption prediction system 1, the delivery data including information based on a delivery route search result as information about the delivery route, vehicle information as information about a traveling electric vehicle, and so forth. Additionally, the delivery system 2 makes a request for calculation of the power consumption. Upon acquiring information on the power consumption from the power consumption prediction system 1, the delivery system 2 determines a charging amount of the electric vehicle as a target on the basis of the power consumption.

The map information described above may include information about a traveling speed limit of each road, information about a temporary stop point, and information about a traffic jam level for each time period. When generating the information on the delivery plan described above, the delivery system 2 may acquire information about the weather from an external device. The information about the weather is, for example, temperature information of each route. The delivery system 2 may acquire traffic jam information from an external device.

The following describes an example of the delivery data transmitted by the delivery system 2 with reference to FIG. 2. FIG. 2 is a diagram for explaining a data structure of the delivery data.

As illustrated in FIG. 2, the delivery data includes a vehicle weight, a motor output, a distance, the number of traffic lights, the number of times of temporary stop, an elevation difference, a congestion degree, a speed limit, a load weight, a day of a week/time, driver information, and information on a temperature. Herein, the vehicle weight is a weight of the electric vehicle, which is information acquired from the vehicle information and the like. The motor output is a motor output of the electric vehicle, which is information acquired from the vehicle information and the like. The distance is a traveling distance of the delivery route, which is information based on the delivery route search result. The number of times of temporary stop indicates the number of temporary stop points on the delivery route, which is information based on the delivery route search result.

The elevation difference indicates an elevation difference on the delivery route, for example, a difference between a traveling start point and a traveling end point. Alternatively, the elevation difference may be a difference between the highest point and the lowest point on the delivery route. The elevation difference is information based on the delivery route search result. The congestion degree is information indicating a congestion degree on the delivery route, for example, an average of a congestion level on the delivery route and the like. The congestion degree is information based on the delivery route search result. The speed limit is information about a speed limit set for a road in the delivery route, for example, an average speed of speed limits of roads in the delivery route. The speed limit is information based on the delivery route search result.

The load weight is a weight of a load on the electric vehicle, which is information based on the vehicle information and the like. The day of the week/time indicates a day of the week/time when delivery is performed, which is information based on the delivery route search result. This information may include not only the day of the week/time but also a date and time. The driver information indicates roughness of driving performed by a driver of the electric vehicle, which is information based on attribute information and the like of the driver of the electric vehicle.

The temperature is information about a temperature during delivery, which is information based on weather information during delivery. The temperature may be a differential temperature as information based on a difference in temperatures. The delivery data described above may include information for identifying the delivery data. The information for identifying the delivery data is, for example, a delivery data ID. The delivery data may also include information other than the information described above. For example, the delivery data may include positional information on the delivery route. As the positional information on the delivery route described above, exemplified are positional information such as a start point, a through point, and a destination point.

The measurement system 3 is, for example, an information processing device such as a server device. The measurement system 3 acquires measurement data including information about the electric mileage at the time of traveling from the electric vehicle, the delivery system 2, and the like, and transmits the measurement data to the power consumption prediction system 1.

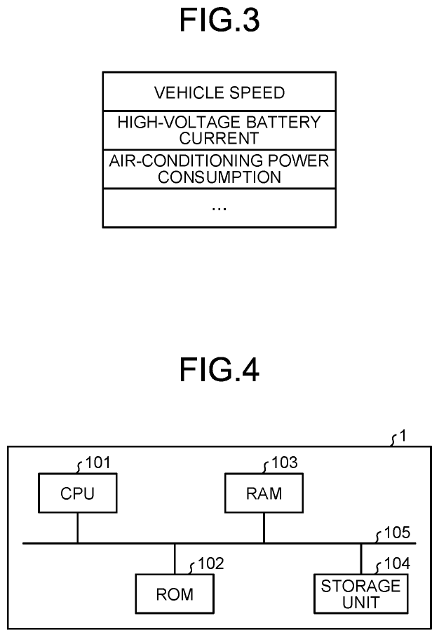

The following describes an example of the measurement data transmitted by the measurement system 3 with reference to FIG. 3. FIG. 3 is a diagram for explaining a data structure of the measurement data.

The measurement data is data including information for calculating the electric mileage. This information includes a vehicle speed, a high-voltage battery current, and an air-conditioning power consumption. The vehicle speed is information about a vehicle speed at the time when the vehicle travels along a search result of the delivery route. The high-voltage battery current is information about a high-voltage battery current as a result of traveling. The air-conditioning power consumption is information indicating an air-conditioning power consumption at the time of traveling. The measurement data may include information for calculating the electric mileage in addition to the information illustrated in FIG. 3. The measurement data may also include the delivery data ID. With this configuration, the delivery data can be associated with the measurement data. The measurement data may further include information included in the delivery data. This is because information at the time of searching for the delivery route may be different from information at the time of actual traveling. For example, a temperature at the time of searching for the delivery route may be different from a temperature at the time of actual traveling.

Hardware Configuration of Power Consumption Prediction System

Next, the following describes a hardware configuration of the power consumption prediction system 1. FIG. 4 is a block diagram illustrating an example of the hardware configuration of the power consumption prediction system 1. The power consumption prediction system 1 includes a central processing unit (CPU) 101, a read only memory (ROM) 102, a random access memory (RAM) 103, and a storage unit 104. The respective constituent elements are electrically connected to each other via a bus line 105.

The CPU 101 controls an operation of the entire power consumption prediction system 1. The ROM 102 stores various computer programs. The RAM 103 temporarily stores various kinds of data and the like. The CPU 101 loads the computer program stored in the ROM 102 and the like into the RAM 103, and operates in accordance with the loaded computer program to control the power consumption prediction system 1.

The storage unit 104 (an example of the storage device) stores various computer programs, data, and the like. In the present embodiment, for example, the storage unit 104 stores various kinds of information and the like. The storage unit 104 is, for example, a solid state drive (SSD), a hard disk drive (HDD), and the like, which hold storage information even when a power supply is turned off.

Functional Configuration of Power Consumption Prediction System

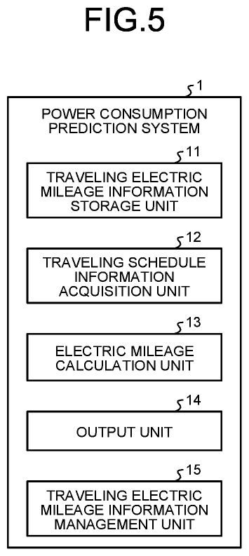

The following describes a function of the power consumption prediction system 1 with reference to FIG. 5. FIG. 5 is a functional block diagram of the power consumption prediction system 1. The power consumption prediction system 1 includes a traveling electric mileage information storage unit 11, a traveling schedule information acquisition unit 12, an electric mileage calculation unit 13, an output unit 14, and a traveling electric mileage information management unit 15.

The traveling electric mileage information storage unit 11 (an example of the storage device) stores information in which traveling history information is associated with the electric mileage of traveling. The traveling history information includes a characteristic of the driver, such as driving roughness and the like. The traveling electric mileage information storage unit 11 stores, for example, information in which the delivery data described above is associated with the electric mileage calculated from the measurement data indicating a result of traveling along the delivery data.

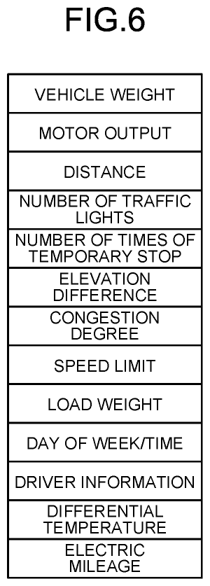

The following describes a data structure of information stored in the traveling electric mileage information storage unit 11 with reference to FIG. 6. FIG. 6 is a diagram for explaining the data structure of the information stored in the traveling electric mileage information storage unit 11.

As illustrated in FIG. 6, the traveling electric mileage information storage unit 11 includes information on a vehicle weight, a motor output, a distance, the number of traffic lights, the number of times of temporary stop, an elevation difference, a congestion degree, a speed limit, a load weight, a day of a week/time, driver information, a differential temperature, and an electric mileage. The information stored in the traveling electric mileage information storage unit 11 is, as described above, information in which the delivery data is associated with the electric mileage calculated from the measurement data indicating a result of traveling along the delivery data. In a case where the measurement data further includes information included in the delivery data, the information included in the delivery data may be associated with the electric mileage to be stored in the traveling electric mileage information storage unit 11 after calculating the electric mileage from the measurement data. The traveling electric mileage information storage unit 11 may further store another information. For example, in a case where the delivery data includes the positional information on the delivery route, the positional information on the delivery route may be stored in the traveling electric mileage information storage unit 11.

Returning to FIG. 5, the traveling schedule information acquisition unit 12 acquires the delivery data including driving roughness. The delivery data corresponds to information about a traveling schedule. The traveling schedule information acquisition unit 12 acquires the delivery data from the delivery system 2, and receives the request for calculation of the power consumption. After acquiring the delivery data, the traveling schedule information acquisition unit 12 sends out the delivery data to the electric mileage calculation unit 13.

The electric mileage calculation unit 13 calculates an electric mileage estimation value on the basis of the information about the delivery data and parameters calculated from the information stored in the traveling electric mileage information storage unit 11.

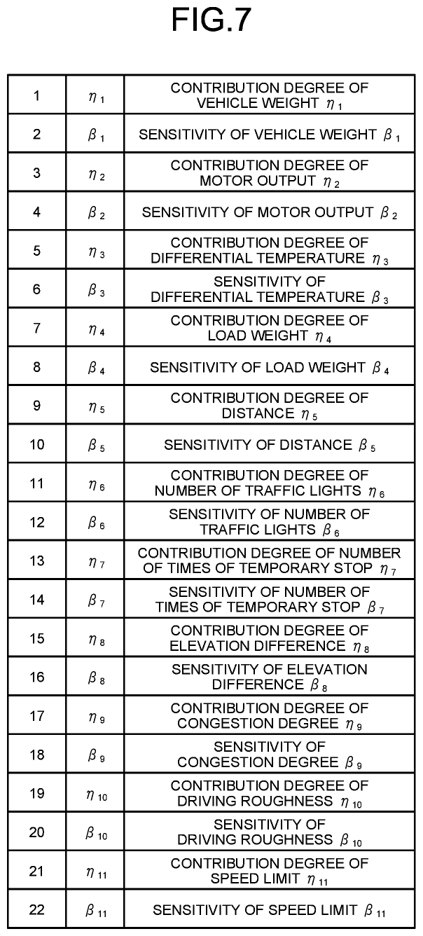

The following describes the parameters calculated from the information stored in the traveling electric mileage information storage unit 11. FIG. 7 illustrates a list of types of the parameters. The electric mileage calculation unit 13 calculates a contribution degree η and a sensitivity β of each element such as the vehicle information, the motor output, and the like as illustrated in FIG. 7.

The electric mileage calculation unit 13 calculates a sensitivity βi by the following expression (1).

$${β}_{i} = \frac{{\sum }_{j = 1}^{N} ( {M}_{j} - \overline{M} ) ( {X}_{ji} - {\overline{X}}_{i} )}{{\sum }_{j = 1}^{N} {( {M}_{j} - \overline{M} )}^{2}} \qquad ( 1 )$$

In the expression (1) described above, N is the number of pieces of data of the information stored in the traveling electric mileage information storage unit 11. That is, N described above is the number of pieces of data from which the parameters are calculated. Mj is information on the electric mileage among the pieces of information stored in the traveling electric mileage information storage unit 11. Xji is information on each element of the information stored in the traveling electric mileage information storage unit 11. For example, Xj1 is information on the vehicle weight in the information stored in the traveling electric mileage information storage unit 11. Xj11 is information on the speed limit in the information stored in the traveling electric mileage information storage unit 11.

In the expression (1) described above, M with an overbar indicates an average value of M1 to MN. In the expression (1), Xi with an overbar indicates an average value of Xi1 to XiN.

The electric mileage calculation unit 13 calculates a contribution degree ηi by the following expressions (2) to (4).

$$\begin{matrix}{η}_{i} = \frac{S {β}_{i}}{{ST}_{i} - S {β}_{i}} & ( 2 ) \\ {ST}_{i} = {\sum }_{j = 1}^{N} {( {X}_{ji} - {\overline{X}}_{ji} )}^{2} & ( 3 ) \\ S {β}_{i} = \frac{{( {\sum }_{j = 1}^{N} ( {M}_{j} - \overline{M} ) ( {X}_{ji} - {\overline{X}}_{i} ) \}}^{2}}{{\sum }_{j = 1}^{N} {( {M}_{j} - \overline{M} )}^{2}} & ( 4 )\end{matrix}$$

In this manner, the electric mileage calculation unit 13 calculates the contribution degree η and the sensitivity β on the basis of a difference between the electric mileage of each piece of data and an average value of electric mileage and a difference between a value of an element of each piece of data and an average value of the value of the element. After calculating the contribution degree η and the sensitivity β, the electric mileage calculation unit 13 holds the contribution degree η and the sensitivity β. The electric mileage calculation unit 13 may be triggered by the request for calculation of the power consumption received from the delivery system 2 for calculating the contribution degree η and the sensitivity β.

Upon acquiring the delivery data from the traveling schedule information acquisition unit 12, the electric mileage calculation unit 13 calculates an electric mileage estimation value on the basis of the delivery data and the parameters including the contribution degree η and the sensitivity β. Specifically, the electric mileage calculation unit 13 calculates the electric mileage estimation value by using the following expression (5).

$${m}_{j} = \frac{{\sum }_{i = 1}^{k} \{ {η}_{i} \times \frac{) {x}_{ji} - {\overline{X}}_{i} )}{{β}_{i}} \}}{{\sum }_{i = 1}^{k} {η}_{i}} + \overline{M} \qquad ( 5 )$$

In the expression (5) described above, xij is information on each element of the delivery data. For example, x1j is information on the vehicle weight in the delivery data, and x11j is information on the speed limit in the delivery data. mj is the electric mileage estimation value. A logarithm may be taken for Mj, an average value of M1 to MN, and mj in the expression (1), the expression (4), and the expression (5) described above. The electric mileage calculation unit 13 may calculate the parameters for part of the elements such that the number of times of temporary stop is omitted, and calculate the electric mileage estimation value on the basis of the parameters. For example, the electric mileage calculation unit 13 may calculate the parameters on the basis of the driving roughness and the vehicle information such as the motor output, and calculate the electric mileage estimation value on the basis of the parameters. Alternatively, the electric mileage calculation unit 13 may calculate the parameters on the basis of the driving roughness and the delivery route search result such as the congestion degree, and calculate the electric mileage estimation value on the basis of the parameters.

After calculating the electric mileage estimation value, the electric mileage calculation unit 13 calculates a power consumption value on the basis of the electric mileage estimation value and the distance of the delivery data, and sends out the power consumption value to the output unit 14. The electric mileage calculation unit 13 sends out the delivery data to the traveling electric mileage information management unit 15.

The output unit 14 outputs information based on the electric mileage estimation value calculated by the electric mileage calculation unit 13. Specifically, upon acquiring the power consumption value as the information based on the electric mileage estimation value from the electric mileage calculation unit 13, the output unit 14 transmits the power consumption value to the delivery system 2. Alternatively, the output unit 14 may acquire the electric mileage estimation value itself from the electric mileage calculation unit 13 and transmit the electric mileage estimation value to the delivery system 2.

Procedure of Electric Mileage Estimation Value Calculation Processing

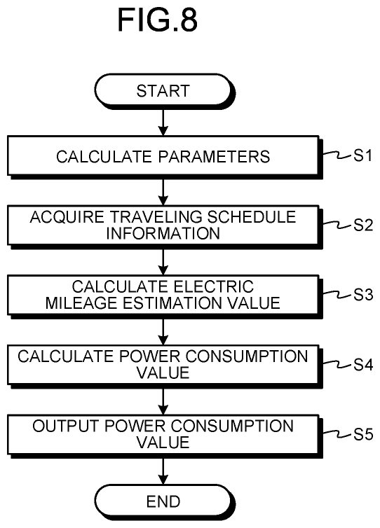

The following describes a processing procedure for calculating the electric mileage estimation value with reference to FIG. 8. FIG. 8 is a flowchart illustrating the processing procedure for calculating the electric mileage estimation value. As a premise, the power consumption prediction system 1 causes the traveling electric mileage information storage unit 11 to store the information in which the traveling history information is associated with the electric mileage of traveling on the basis of the information acquired from the delivery system 2 and the measurement system 3.

First, the electric mileage calculation unit 13 calculates the parameters including the contribution degree η and the sensitivity β in advance on the basis of the information stored in the traveling electric mileage information storage unit 11, and holds the calculated parameters (Step S1).

Subsequently, the traveling schedule information acquisition unit 12 acquires the delivery data as the traveling schedule information from the delivery system 2 and receives the request for calculation of the power consumption (Step S2). Subsequently, the electric mileage calculation unit 13 calculates the electric mileage estimation value on the basis of the delivery data and the parameters (Step S3).

The electric mileage calculation unit 13 calculates the power consumption value on the basis of the electric mileage estimation value (Step S4). The output unit 14 transmits the power consumption value to the delivery system 2 (Step S5).

Returning to FIG. 5, the traveling electric mileage information management unit 15 acquires additional information in which the traveling history information is associated with the electric mileage. Additionally, the traveling electric mileage information management unit 15 causes the traveling electric mileage information storage unit 11 to store the additional information.

The traveling electric mileage information management unit 15 acquires the delivery data from the electric mileage calculation unit 13. The traveling electric mileage information management unit 15 also acquires the measurement data corresponding to the delivery data described above from the measurement system 3. The measurement data corresponding to the delivery data described above is measurement data the delivery data whose ID is identical to the delivery data ID of the delivery data. The traveling electric mileage information management unit 15 calculates the electric mileage of an actual traveling result from the information included in the measurement data. The traveling electric mileage information management unit 15 holds registration candidate data as the information in which the delivery data described above is associated with the electric mileage. At a stage when a given number of pieces of the registration candidate data are prepared, the traveling electric mileage information management unit 15 determines whether to register the pieces of the registration candidate data in the traveling electric mileage information storage unit 11. The given number described above is, for example, 100.

At the stage when the given number of pieces of the registration candidate data are prepared, the traveling electric mileage information management unit 15 extracts, from the traveling electric mileage information storage unit 11, data for verification as information corresponding to a specified level. The data corresponding to the specified level may be, for example, data each of whose elements does not indicate an extreme value. The traveling electric mileage information management unit 15 may narrow the registration candidate data down to data satisfying a specified level.

The traveling electric mileage information management unit 15 calculates a first electric mileage estimation value as an electric mileage estimation value, on the basis of the data for verification and the parameters stored in the electric mileage calculation unit 13. Specifically, the traveling electric mileage information management unit 15 calculates the first electric mileage estimation value by applying the data for verification and the parameters stored in the electric mileage calculation unit 13 to the expression (5) described above. Subsequently, the traveling electric mileage information management unit 15 calculates a correlation coefficient on the basis of the first electric mileage estimation value.

Specifically, the traveling electric mileage information management unit 15 calculates the correlation coefficient by using the following expression (6).

$$R = \frac{{\sum }_{j = 1}^{n} ( {m}_{j} - \overline{m} ) \times ( {m}_{ij} - \overline{{m}_{0}} )}{\sqrt{( {\sum }_{j = 1}^{n} {( {m}_{j} - \overline{m} )}^{2} ) \times ( {\sum }_{j = 1}^{n} {( {m}_{ij} - \overline{{m}_{0}} )}^{2} )}} \qquad ( 6 )$$

In the expression (6) described above, mj is the first electric mileage estimation value. m with an overbar is an average value of mj. m0j is a value of the electric mileage in the data for verification. m0 with an overbar is an average value of m0. In this manner, the traveling electric mileage information management unit 15 calculates the correlation coefficient on the basis of: a difference between the first electric mileage estimation value in each piece of the data for verification and the average value of the first electric mileage estimation value, and a difference between the value of the electric mileage in each piece of the data for verification and the average value of the value of the electric mileage.

The traveling electric mileage information management unit 15 calculates the parameters by using the registration candidate data. Specifically, in the expression (1) to expression (4) described above, the traveling electric mileage information management unit 15 calculates the parameters by changing the information stored in the traveling electric mileage information storage unit 11 to the registration candidate data.

The traveling electric mileage information management unit 15 also calculates a second electric mileage estimation value as an electric mileage estimation value on the basis of the data for verification and the parameters using the registration candidate data. Specifically, the traveling electric mileage information management unit 15 calculates the second electric mileage estimation value by applying the data for verification and the parameters using the registration candidate data to the expression (5) described above. Subsequently, the traveling electric mileage information management unit 15 calculates a correlation coefficient on the basis of the second electric mileage estimation value.

Specifically, the traveling electric mileage information management unit 15 calculates the correlation coefficient by using the following expression (7).

$${R}^{′} = \frac{{\sum }_{j = 1}^{n} ( {m}_{j}^{′} - \overline{{m}^{′}} ) \times ( {m}_{0 j} - \overline{{m}_{0}} )}{\sqrt{( {\sum }_{j = 1}^{n} {( {m}_{j}^{′} - \overline{{m}^{′}} )}^{2} ) \times ( {\sum }_{j = 1}^{n} {( {m}_{oj} - \overline{{m}_{0}} )}^{2} )}} \qquad ( 7 )$$

In the expression (7) described above, mj′ is the second electric mileage estimation value. m′ with an overbar is an average value of mj. m0j is a value of the electric mileage in the data for verification. m0 with an overbar is an average value of m0. In this manner, the traveling electric mileage information management unit 15 calculates the correlation coefficient on the basis of: a difference between the second electric mileage estimation value in each piece of the data for verification and the average value of the second electric mileage estimation value, and a difference between the value of the electric mileage in each piece of the data for verification and the average value of the value of the electric mileage.

The traveling electric mileage information management unit 15 determines whether to register the registration candidate data by comparing the correlation coefficient based on the first electric mileage estimation value and the correlation coefficient based on the second electric mileage estimation value.

For example, in a case where a difference value between a correlation coefficient R′ based on the second electric mileage estimation value and the correlation coefficient R based on the first electric mileage estimation value exceeds a predetermined threshold, the traveling electric mileage information management unit 15 decides to register the registration candidate data. In this case, the traveling electric mileage information management unit 15 registers the registration candidate data in the traveling electric mileage information storage unit 11. The threshold described above is −0.02, for example. In this manner, in a case of determining that the electric mileage can be estimated with high accuracy when the electric mileage is estimated with the parameters using the registration candidate data as compared with a case where the electric mileage is estimated with the parameters stored in the electric mileage calculation unit 13, the traveling electric mileage information management unit 15 registers the registration candidate data in the traveling electric mileage information storage unit 11.

In the example described above, the traveling electric mileage information management unit 15 decides to register the registration candidate data on the basis of a result of comparing the correlation coefficient R′ based on the second electric mileage estimation value and the correlation coefficient R based on the first electric mileage estimation value. However, the embodiment is not limited thereto.

For example, the traveling electric mileage information management unit 15 may calculate an accuracy difference based on the first electric mileage estimation value and an accuracy difference based on the second electric mileage estimation value, and may register the registration candidate data in a case where the accuracy difference based on the first electric mileage estimation value is larger than the accuracy difference based on the second electric mileage estimation value as a result of comparing them.

The accuracy difference based on the first electric mileage estimation value described above is calculated by using the following expression (8). In the expression (8), dm is the accuracy difference on the basis of the first electric mileage estimation value. In this manner, the traveling electric mileage information management unit 15 calculates information indicating the accuracy difference between the first electric mileage estimation value and the electric mileage at the time of actual traveling.

$$dm = \frac{{\sum }_{j = 1}^{n} \vert 1 - \frac{{m}_{j}}{{m}_{0 j}} \vert}{n} \qquad ( 8 )$$

The accuracy difference based on the second electric mileage estimation value described above is calculated by using the following expression (9). In the expression (9), dm′ is the accuracy difference on the basis of the second electric mileage estimation value. In this manner, the traveling electric mileage information management unit 15 calculates information indicating the accuracy difference between the second electric mileage estimation value and the electric mileage at the time of actual traveling.

$${dm}^{′} = \frac{{\sum }_{j = 1}^{n} \vert 1 - \frac{{m}_{j}^{′}}{{m}_{0 j}} \vert}{n} \qquad ( 9 )$$

The traveling electric mileage information management unit 15 may determine whether to register the registration candidate data by comparing: the correlation coefficient and the accuracy difference each based on the first electric mileage estimation value, and the correlation coefficient and the accuracy difference each based on the second electric mileage estimation value. For example, in a case where a difference value between the correlation coefficient R′ based on the second electric mileage estimation value and the correlation coefficient R based on the first electric mileage estimation value exceeds a predetermined threshold, and the accuracy difference dm based on the first electric mileage estimation value is larger than the accuracy difference dm′ based on the second electric mileage estimation value, the traveling electric mileage information management unit 15 may decide to register the registration candidate data. In this case, the registration candidate data is registered in the traveling electric mileage information storage unit 11.

Note that, at a timing of registering the registration candidate data in the traveling electric mileage information storage unit 11, the electric mileage calculation unit 13 may recalculate the parameters on the basis of the information stored in the traveling electric mileage information storage unit 11.

Procedure of Registration Candidate Data Registration Processing

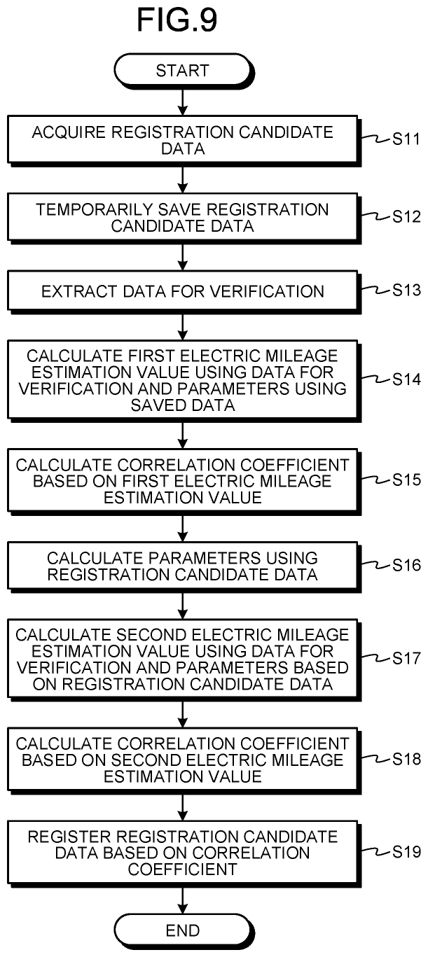

The following describes a processing procedure for registering the registration candidate data with reference to FIG. 9. FIG. 9 is a flowchart illustrating the processing procedure for registering the registration candidate data.

First, the traveling electric mileage information management unit 15 acquires the registration candidate data by obtaining the delivery data and the measurement data corresponding to the delivery data and calculating the electric mileage on the basis of the measurement data (Step S11). The traveling electric mileage information management unit 15 temporarily holds the registration candidate data (Step S12). In a case where a predetermined number of pieces of the registration candidate data have been held, the traveling electric mileage information management unit 15 extracts data for verification from the traveling electric mileage information storage unit 11 (Step S13).

The traveling electric mileage information management unit 15 calculates the first electric mileage estimation value by using the data for verification and the parameters based on the information stored in the traveling electric mileage information storage unit 11 (Step S14). The parameters based on the information in the traveling electric mileage information storage unit 11 are parameters held by the electric mileage calculation unit 13. The traveling electric mileage information management unit 15 calculates the correlation coefficient and the accuracy difference on the basis of the first electric mileage estimation value (Step S15).

The traveling electric mileage information management unit 15 calculates the parameters by using the registration candidate data (Step S16). The traveling electric mileage information management unit 15 calculates the second electric mileage estimation value by using the data for verification and the parameters based on the registration candidate data (Step S17). The traveling electric mileage information management unit 15 calculates the correlation coefficient and the accuracy difference on the basis of the second electric mileage estimation value (Step S18).

The traveling electric mileage information management unit 15 registers the registration candidate data in the traveling electric mileage information storage unit 11 on the basis of the correlation coefficient and the accuracy difference on the basis of the first electric mileage estimation value and the correlation coefficient and the accuracy difference on the basis of the second electric mileage estimation value (Step S19).

In the above description, the traveling electric mileage information management unit 15 registers the information in the traveling electric mileage information storage unit 11 when a predetermined number of pieces of the registration candidate data have been acquired and held. Alternatively, the traveling electric mileage information management unit 15 may perform update processing for the information in the traveling electric mileage information storage unit 11 at another timing, or may recalculate the parameters.

For example, it is assumed that the positional information on the delivery route included in the delivery data acquired by the traveling schedule information acquisition unit 12 is often largely different from the positional information on the delivery route of the information in the traveling electric mileage information storage unit 11. In this case, the traveling electric mileage information management unit 15 may make a setting to remove, from a parameter calculation target, the information in the traveling electric mileage information storage unit 11 corresponding to the positional information that is largely different from the positional information on the delivery route included in the delivery data acquired by the traveling schedule information acquisition unit 12, by deleting this information, or moving this information to another storage region. The positional information on the delivery route is, for example, positional information about a destination.

The traveling electric mileage information management unit 15 may make a setting such that only the information in the traveling electric mileage information storage unit 11 including a date and time of a season corresponding to a date and time of the delivery data acquired by the traveling schedule information acquisition unit 12 becomes a parameter calculation target, and may make a setting to remove the other pieces of information in the traveling electric mileage information storage unit 11 from the parameter calculation target by deleting the other pieces of information or moving the other pieces of information to another storage region, for example. In such a case, the date and time corresponding to each season are set in advance.

The traveling electric mileage information management unit 15 may also make a setting such that only the information in the traveling electric mileage information storage unit 11 corresponding to a differential temperature of the delivery data acquired by the traveling schedule information acquisition unit 12 becomes a parameter calculation target, and make a setting to remove the other pieces of information in the traveling electric mileage information storage unit 11 from the parameter calculation target by deleting the other pieces of information or moving the other pieces of information to another storage region, for example.

As described above, the traveling electric mileage information management unit 15 may perform editing processing such as update processing for the information in the traveling electric mileage information storage unit 11 on the basis of a condition related to positional information, a condition related to a season, and a condition related to a temperature. The electric mileage calculation unit 13 may recalculate the parameters using new information as a parameter calculation target in accordance with the update processing.

Method for Specifying Driving Degree

The following describes a method for specifying driving roughness in the elements included in the delivery data and the like. By way of example, a driving degree such as driving roughness of the driver is specified by using an MT method. The driving degree of the driver may be specified by the power consumption prediction system 1, or may be specified by the delivery system 2. Herein, it is assumed that the delivery system 2 specifies the driving degree of the driver.

As a premise, traveling data of the driver whose electric mileage is good has been acquired. The traveling data is data indicating behavior of the vehicle and so forth at the time of driving. Additionally, it is assumed that traveling data of another driver, who is a target of characteristic determination, has also been acquired.

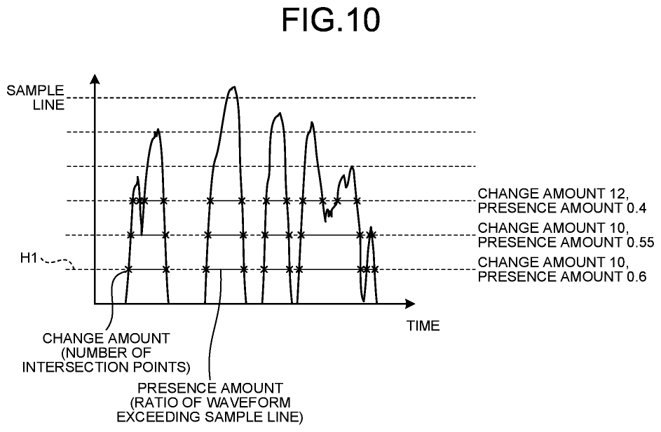

First, the delivery system 2 specifies a change amount and a presence amount of the traveling data of each driver for each fixed time or each traveling section. The following describes the change amount and the presence amount of the traveling data with reference to FIG. 10. FIG. 10 is a diagram for explaining the change amount and the presence amount of the traveling data.

In the graph illustrated in FIG. 10, the horizontal axis indicates a time, and the vertical axis indicates a result of the traveling data measured at the time of traveling. Sample lines are set in the graph. The change amount and the presence amount are calculated on the basis of the contrast between the traveling data and the sample lines. The sample lines are set at intervals per given amount in a predetermined range, for example.

The change amount is the number of intersection points of a waveform of the traveling data and the sample line. The presence amount is a ratio of the waveform exceeding the sample line. In a case of a sample line H1, the change amount is “10” and the presence amount is “0.6”.

The delivery system 2 calculates the change amount and the presence amount as illustrated in FIG. 10 by segmenting the traveling data of each driver at given time intervals or given sectional intervals.

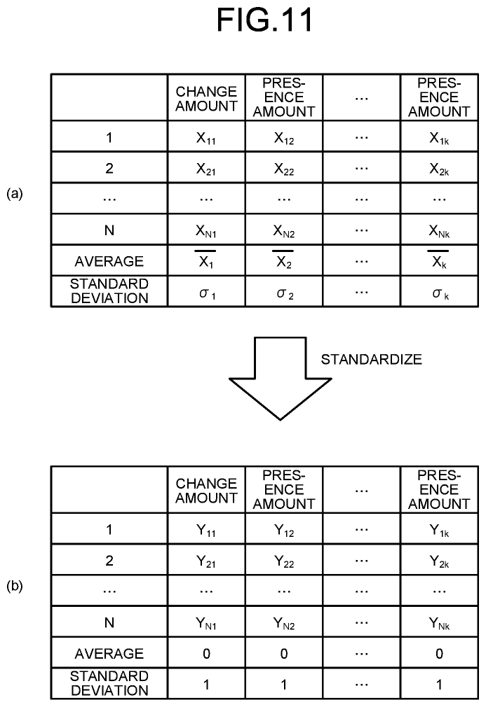

A table (a) in FIG. 11 is an example of the change amount and the presence amount regarding each sample line for N times or sections of the driver whose electric mileage is good. A standard deviation σi the table (a) in FIG. 11 can be calculated by the expression (10).

$${σ}_{i} = \sqrt{\frac{{\sum }_{j = 1}^{m} {( {X}_{ji} - {\overline{X}}_{i} )}^{2}}{N}} \qquad ( 10 )$$

As illustrated in a table (b) in FIG. 11, the delivery system 2 standardizes each piece of the data with an average value and a standard deviation for each type of K pieces of information such as the change amount and the presence amount. Specifically, the data is standardized on the basis of the expression (11).

$${Y}_{ji} = \frac{{X}_{ji} - {\overline{X}}_{i}}{{σ}_{i}} \qquad ( 11 )$$

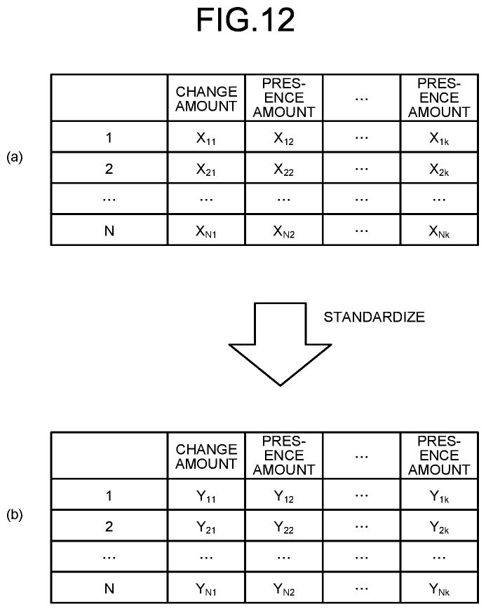

A table (a) in FIG. 12 is an example of the change amount and the presence amount regarding each sample line for N times or sections of the driver who is a target of characteristic determination. Similarly to the information illustrated in FIG. 11, as illustrated in a table (b) in FIG. 12, the delivery system 2 standardizes each piece of the data with an average value and a standard deviation for each type of K pieces of information. Specifically, the data is standardized on the basis of the expression (12).

$${y}_{ji} = \frac{{x}_{ji} - {\overline{X}}_{i}}{{σ}_{i}} \qquad ( 12 )$$

The delivery system 2 then calculates, on the basis of the standardized information, a correlation coefficient matrix on the basis of the expression (13).

$${R}_{st} = \frac{1}{N} {\sum }_{j = 1}^{m} ( {Y}_{js} \times {Y}_{jt} ) \qquad ( 13 )$$

The delivery system 2 then calculates an MD value on the basis of the expression (14) including an inverse matrix R-1st of the correlation coefficient matrix.

$${D}_{j} = \sqrt{\frac{1}{k} {\sum }_{s = 1}^{k} {\sum }_{t = 1}^{k} {y}_{js} {R}_{st}^{- 1} {y}_{jt}} \qquad ( 14 )$$

This MD value indicates a distance to a unit space that is formed on the basis of a result of the traveling data of the driver whose electric mileage is good. A characteristic of the driver as a target of characteristic determination is determined on the basis of the distance indicated by the MD value. For example, in a case where the calculated MD value is larger than a threshold determined in advance, the delivery system 2 determines that driving of the target driver is rough. This is because the large MD value indicates that a change in a result indicated by the traveling data is extreme, and the extreme change indicates that driving is rough. Additionally, when a change in the result indicated by the traveling data is extreme, a load is applied to the electric vehicle, and the electric mileage tends to be worse. The electric mileage tends to be influenced by the driving degree such as driving roughness of the driver.

In the example described above, described is a case of determining the characteristic of the driver using the change amount and the presence amount of the traveling data, but other information may be used.

In the example described above, described is a case of determining the characteristic of the driver by the MT method, but the characteristic of the driver may be determined by other various methods. For example, the delivery system 2 may determine the characteristic of the driver on the basis of the number of times of sudden braking, the number of times of unnecessary turning back at the time of parking, and the like specified from the traveling data. In the example described above, described is a case where the traveling electric mileage information storage unit 11 stores the information based on the actual traveling result, but may store information on a result of a simulation.

As described above, the traveling electric mileage information storage unit 11 of the power consumption prediction system 1 stores the information in which the electric mileage of traveling and the traveling history information including the characteristic of the driver are associated with each other. When the traveling schedule information acquisition unit 12 acquires the delivery data including the characteristic of the driver, the electric mileage calculation unit 13 calculates the electric mileage estimation value on the basis of the delivery data and the parameters calculated from the information stored in the traveling electric mileage information storage unit 11. Then, the output unit 14 outputs the information based on the electric mileage estimation value. As described above, in a case where driving is rough, a load is applied to the electric vehicle, and thereby the electric mileage tends to be worse. In considering this point, the power consumption prediction system 1 estimates the electric mileage using the parameters considering the characteristic of the driver and the delivery data including the characteristic of the driver. Therefore, the electric mileage can be estimated more appropriately.

The power consumption prediction system 1 calculates the electric mileage estimation value by using the parameters considering the characteristic of the driver as described above. Then, the power consumption prediction system 1 outputs, to the delivery system 2, a power consumption amount using the electric mileage estimation value. The delivery system 2 is able to appropriately develop a traveling plan on the basis of the acquired power consumption amount. For example, the power consumption amount described above is an electric mileage estimation value using the parameters considering the characteristic of the driver, and estimation accuracy thereof is high. Thus, the delivery system 2 can output a remaining travelable distance of the electric vehicle with high accuracy. Additionally, the power consumption amount with high accuracy is acquired from the power consumption prediction system 1. Therefore, the electric vehicle is not required to be unnecessarily charged, and a charge plan can be appropriately made.

The power consumption prediction system 1 according to the present embodiment may be configured to provide or distribute, to the vehicle, an estimated electric mileage, a power consumption on the basis of the electric mileage, the parameters of the present embodiment, registration candidate data, and the like via a network such as the Internet. By way of example, as one aspect, in a case of providing the registration candidate data to the vehicle, the vehicle may calculate the electric mileage estimation value on the basis of the registration candidate data. In this aspect, the vehicle has a configuration similar to that of the electric mileage calculation unit 13, and calculates the electric mileage estimation value on the basis of the registration candidate data.

The computer program executed by the power consumption prediction system 1 according to the present embodiment is recorded and provided in a computer-readable recording medium such as an optical recording medium such as a digital versatile disc (DVD), a USB memory, a semiconductor memory device such as a solid state disk (SSD), and the like as an installable or executable file.

The computer program executed by the power consumption prediction system 1 according to the present embodiment may be stored in a computer connected to a network such as the Internet, and provided by being downloaded via the network. The computer program executed by the power consumption prediction system 1 according to the present embodiment may be provided or distributed via a network such as the Internet.

The computer program of the power consumption prediction system 1 according to the present embodiment may be embedded and provided in a ROM, for example.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

The effects of the embodiment described herein are merely examples, and not limited thereto. Other effects may be exhibited.

What is claimed is:

1. An electric mileage estimation apparatus comprising:
a storage device configured to store information in which traveling history information is associated with an electric mileage of traveling, the traveling history including a characteristic of a driver; and
a hardware processor connected to the storage device, the hardware processor being configured to
acquire information about a traveling schedule including a characteristic of a driver,
calculate an electric mileage estimation value on the basis of the information about the traveling schedule and parameters calculated from the information stored in the storage device, and
output information based on the electric mileage estimation value.

2. The electric mileage estimation apparatus according to claim 1, wherein the hardware processor is configured to
acquire additional information in which the traveling history information is associated with the electric mileage, and
cause the storage device to store the additional information in a case where the additional information meets a predetermined condition.

3. The electric mileage estimation apparatus according to claim 2, wherein the hardware processor is configured to cause the storage device to store the additional information on the basis of a result of comparison between a first electric mileage estimation value and a second electric mileage estimation value, the first electric mileage estimation value being calculated on the basis of the traveling history information stored in the storage device and parameters calculated from the information stored in the storage device, the second electric mileage estimation value being calculated on the basis of the traveling history information stored in the storage device and parameters calculated from the additional information.

4. The electric mileage estimation apparatus according to claim 3, wherein the hardware processor is configured to cause the storage device to store the additional information on the basis of a result of comparison of correlation coefficients or accuracy difference values between the first electric mileage estimation value and the second electric mileage estimation value.

5. The electric mileage estimation apparatus according to claim 2, wherein the hardware processor is configured to edit the information stored in the storage device in a case where the information meets a predetermined condition.

6. The electric mileage estimation apparatus according to claim 5, wherein the predetermined condition is any of a condition related to positional information, a condition related to a season, and a condition related to a temperature.

7. The electric mileage estimation apparatus according to claim 1, wherein the hardware processor is configured to output, as the information based on the electric mileage estimation value, a power consumption value using the electric mileage estimation value.

8. The electric mileage estimation apparatus according to claim 1, wherein the traveling history information and the information about the traveling schedule further include vehicle information or information based on route search.

9. An electric mileage estimation method implemented by a computer, the method comprising:
storing, in a storage device, information in which traveling history information is associated with an electric mileage of traveling, the traveling history including a characteristic of a driver;
acquiring information about a traveling schedule including a characteristic of a driver;
calculating an electric mileage estimation value on the basis of the information about the traveling schedule and parameters calculated from the information stored in the storage device, and
outputting information based on the electric mileage estimation value.

10. A non-transitory computer-readable recording medium on which programmed instructions are recorded, the instructions causing a computer to execute processing, the processing comprising:
storing, in a storage device, information in which traveling history information is associated with an electric mileage of traveling, the traveling history including a characteristic of a driver;
acquiring information about a traveling schedule including a characteristic of a driver;
calculating an electric mileage estimation value on the basis of the information about the traveling schedule and parameters calculated from the information stored in the storage device, and
outputting information based on the electric mileage estimation value.
